(19) United States
(12) Patent Application Publication
(10) Pub. No.: US 2014/0104562 A1
(43) Pub. Date: Apr. 17, 2014

(54) GLASSES HAVING REPLACEABLE LEG USING MAGNETS

(71) Applicant: Jang Rak Kim, Gyeongsangbuk-do (KR)

(72) Inventor: Jang Rak Kim, Gyeongsangbuk-do (KR)

(21) Appl. No.: 14/123,180

(22) PCT Filed: May 29, 2012
(86) PCT No.: PCT/KR2012/004203

§ 371 Date: Nov. 29, 2013

(30) Foreign Application Priority Data
May 31, 2011 (KR) 10-2011-0051980

(51) Int. Cl. G02C 5/14

(52) U.S. Cl. CPC G02C 5/146
USPC 351/116

(57) ABSTRACT

The present invention relates to glasses having a leg which can be detachable from a connector of an eyeglass frame (10), wherein the invention comprises: a connecting rod (20) which is formed on a side of said eyeglass frame (10), and has a hinge groove (21); a leg (30) having a hinge end (31), which is inserted into the hinge groove (21) of said connecting rod (20) and is rotatable therein; and magnets (40) which are respectively mounted on surfaces on which said connecting rod (20) and the leg (30) are in contact with each other, and support the leg in a detachable manner, wherein detachable means are installed by selecting whether said magnets (40) are to be exposed or embedded inside. Thus, the present invention enables: solid combination to be maintained and easy assembling and replacing operations to be performed, by adopting a magnetism-dependent form; the leg to be foldable even without constituting a hinge, thereby maintaining a natural, unfolded state; and a fashion sense to be enhanced by easily and quickly replacing, when necessary, various types of legs or the like.

### CROSS-REFERENCE TO RELATED APPLICATION

This application claims the benefit of Korean Patent Application No.10-2011-0051980, filed on May 31, 2011 in the Korean Intellectual Property Office, the disclosure of which is incorporated herein by reference.

### TECHNICAL FIELD

The present disclosure in one or more embodiments relates to a detachable eyeglasses leg. More particularly, the present disclosure relates to eyeglasses having a magnetically coupled and detachable leg, which employs the magnetism for reliably providing enduring coupling forces to facilitate the assembly of glasses and the replacement of the leg and to render the leg to be simply foldable and compliantly wearable while improving the replaceability of a variety of leg designs to highlight fashionability.

### BACKGROUND

Eyeglasses are to usually wear over human eyes which reveal the immediate changes in facial expression and they offer a significant change in image and appearance of the wearers who have the shared need for some degree of makeover which is satisfied by the eyeglasses. Such ‘makeover effect’ of the glasses has repositioned the utensil that was frequently viewed as “vision correction device” or “shade” into a newly valued fashion wear in the current trend of respecting fashionability of people. As society becomes rich with resources, this trend gets increasingly prominent which requires the fashion wear to be more personalized and fashionable.

As an example, arm or leg parts for use with eyeglasses are classified, manufactured and marketed by injection molding products of a synthetic resin, wood legs, different metal legs, legs of combined materials, and the likes. However, such legs lack fanciness since they are manufactured with very limited shapes and types, which disinterested consumers from seeking a fashion sensibility. To keep pace with the current change in the market, the glasses industry has recently launched more diverse legs to highlight the fanciness and fashionability.

The relevant prior art known to the inventor is Korean laid-open patent publication No. 2010-0135402 entitled “Glasses Which Include Magnet Parts between an Eyeglasses Frame and Legs” and Korean laid-open patent publication No. 2008-0096972 entitled “Connection Structure of the Glasses Using the Magnetic Force”.

For example, Korean publication No. 2010-0135402 discloses a method wherein magnets are attached in line to legs near their joints with an eyeglasses frame to normally fix the legs to the frame. When an external impact is occurred to the eyeglasses frame and legs, the magnets are separated from each other in order to prevent the breakage of the eyeglasses frame and the legs.

This structure is fixed by forming magnets in between the legs and the eyeglass frame to maintain the fixture normally and absorb external impacts by disengagement, but the coupling portion may take an excessive load to easily override the magnetic force alone, which incapacitate the glasses from working properly. In addition, it uses a mechanical hinge for opening and closing the legs to make it cumbersome to replace legs for the sake of fashionability. This approach is short of adding or renewing values of visual aesthetic sense.

Another example of Korean publication No. 2008-0096972 discloses a connection structure of the glasses having legs(30) and metal ornaments(10) for connecting the legs to the frame using the magnetic force, comprising a first connection unit including at least a couple of first magnets and hinge interposed in one end of the metal ornament; a second connection unit formed at one end of the bow on a pair of legs and including the second magnet corresponding with the first connection unit; and a connecting band for surrounding and binding the first connection unit and the second connection unit together.

However, according to the above prior art structure, the absence of nuts and bolts may help to implement the functionality of detachably assembling the legs with ease, but the incorporations of the metal ornaments and the connecting band will adversely affect the visual aesthetics and the diversification of fashions.

### DISCLOSURE

### Technical Problem

To meet the need for an improvement by the present disclosure, eyeglasses having the magnet-assisted detachable leg employs the magnetism for reliably providing enduring coupling forces to facilitate the assembly of glasses and the replacement of the leg and to render the leg to be simply foldable without sophisticated structures of hinge parts and to be compliantly wearable while improving the replaceability of a variety of leg designs as needed to highlight fashionability.

### SUMMARY

In accordance with some embodiments of the present disclosure, eyeglasses having a frame magnetically coupled with detachable legs, comprises an end piece, at least one leg and a detachable means. The end piece may be formed on each side of the frame and having a hinge groove. The at least one leg may include a hinge tip for inserting the leg in the hinge groove of the end piece for allowing the leg to swivel. And the detachable means may include a number of magnets combined respectively with opposing sides of the end piece and the leg to releasably hold the leg to the end piece, the magnets being formed exposed, embedded or both at the opposing sides.

In addition, the leg has stoppers for controlling a pivotal angle range of the leg in engagement with the hinge groove of the end piece by interfering with the swivel of the leg.

The terms used in the specification and claims should not be construed as limiting to mean typically or lexically, but are to be construed to mean in context with the technical idea of the present disclosure based on the principle that an inventor can define the concept of an object or thought properly to best describe the disclosure in mind. Therefore, the configuration shown in the drawings and the embodiments described herein are merely an exemplary embodiment of the present disclosure to be written rather than completely listed, and it should be understood that there are various modifications and equivalents for substituting the disclosure at the present time of this application.

### Advantageous Effects

According to the configuration and operation described above, the eyeglasses having the magnet-assisted detachable leg employs the magnetism for reliably providing enduring coupling forces to facilitate the assembly of glasses and the replacement of the leg and to render the leg to be simply foldable without sophisticated structures of hinge parts and to be compliantly wearable while improving the replaceability of a variety of leg designs as needed to highlight fashionability.

### DESCRIPTION OF DRAWINGS

FIG. 1 is an exploded perspective view of glasses according to at least one embodiment of the present disclosure.

FIG. 2(a) and (b) are exploded perspective view of the main part of glasses according to at least one embodiment of the present disclosure.

FIG. 3 is a perspective view of an assembly process of the glasses according to at least one embodiment of the present disclosure.

FIG. 4(a), (b) and (c) are diagram of a configuration and operation steps of the glasses according to the present disclosure.

FIG. 5(a) and (b) are cross-sectional diagram of a configuration of the main part of glasses according to a modification of the present disclosure.

### DETAILED DESCRIPTION

Hereinafter, at least one embodiment of the present disclosure will be described in detail with reference to the accompanying drawings.

The present disclosure relates to eyeglasses having a frame 10 with detachable arms or legs at the frame-leg connection. Specifically, the detachable legs refer to an assembled structure of replaceable or removable joint fitting assisted by a magnetic force. Here, the glasses frame 10 is adapted to support lens of the glasses and is made of a synthetic resin, a metal or any other applicable materials.

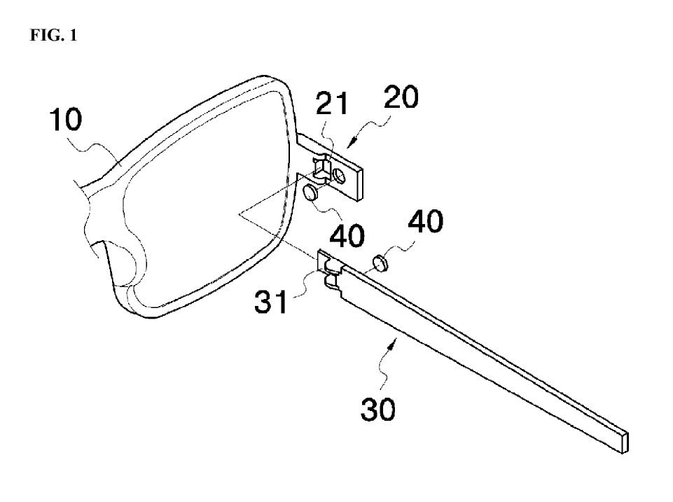

According to the present disclosure, frame 10 employs two end pieces 20 each having a hinge groove 21. As illustrated, end piece 20 is formed integrally on the side surface of frame 10, and it may be formed either as an integral part of frame 10 or additionally formed and welded or fused to frame 10. Referring to FIGS. 1 to 3, end piece 20 has on its inner face a hinge groove 21 provided with a through hole. Hinge groove 21 is formed so as to pivotably receive a hinge tip 31 of a leg 30 to enable leg 30 to swivel as will be described later.

According to the present disclosure, leg 30 utilizes its hinge tip 31 for insertion in hinge groove 21 of end piece 20 to permit leg 30 to pivot. As with frame 10, leg 30 is injection molded of a resin or plastically processed from a metal into an arm member that projects past and behind the wearer's ear. Leg 30 is metal based and may have an additional resin leg cover at its distal end.

As shown in FIGS. 1-3, leg 30 is terminated by hinge tip 31 that is inserted in hinge groove 21 of end piece 20 to allow leg 30 to securely fold and unfold about hinge groove 21. When leg 30 pivots on end piece 20, the engagement between hinge groove 21 of end piece 20 and hinge tip 31 of leg 30 is dynamically maintained against inadvertent disengagement by a detachable unit to be detailed in the following description.

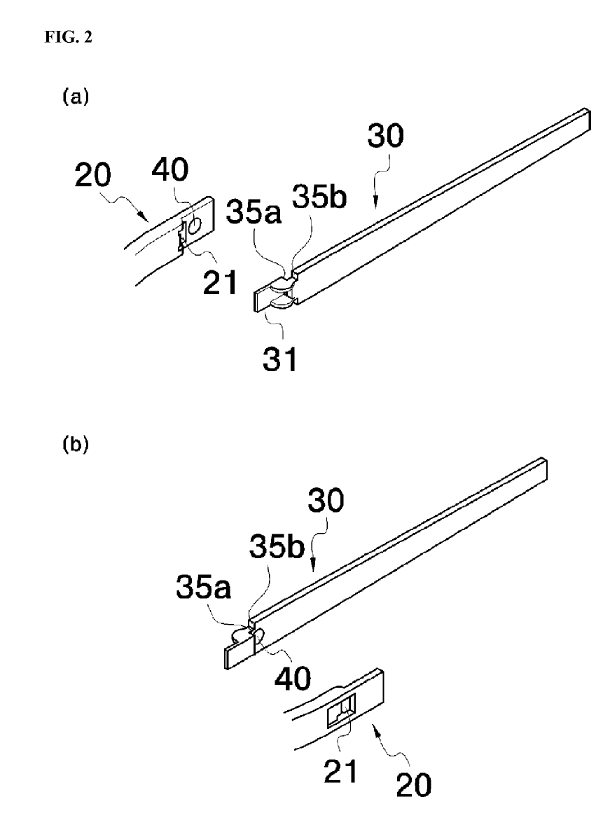

In the present disclosure, leg 30 has stoppers 35a and 35b for engaging with hinge groove 21 of end piece 20 to limit the rotational angular range of leg 30. Legs 30 are yielded to accommodate shocks received but an excessive opening thereof would render the glasses unwearable. In order to limit the rotational angular range of leg 30, stopper 35a defines the opening angle of leg 30 at an open position when it is unfolded in a swivel motion while stopper 35b defines the opening angle when leg 30 is folded back to rest, as illustrated in FIGS. 2 to 4. This operation is carried out in cooperation with hinge groove 21 of end piece 20.

According to the present disclosure in some embodiments, end piece 20 and leg 30 are respectively provided with a detachable unit including magnets 40 which are mounted on contact surfaces of end piece 20 and leg 30 for detachably holding leg 30 onto end piece 20. By maintaining the releasable bind between end piece 20 and leg 30, the detachable unit enables easy and quick replacements of various shapes of legs as needed. Magnets 40 are respectively attached to the contact surfaces of end piece 20 and leg 30, and as shown particularly in FIG. 2, one magnet 40 is formed on a surface adjacent to hinge groove 21 of end piece 20 and the other magnet 40 is formed on the corresponding surface of hinge tip 31 of leg 30 so that they can fully engage each other. Thanks to the magnetic force of magnets 40 as the detachable unit, hinge tip 31 of leg 30 can securely swivel about hinge groove 21 of end piece 20 without a concern of inadvertent disengagement.

Magnetic force of these magnets 40 may be 100-2000 Gauss, and in particular 1000-1500 Gauss. The smaller and stronger magnets, the better and they are disposed by taking account of harmonization with end piece 20 and leg 30 to keep magnets 40 from adversely affecting the aesthetics of the eyeglasses in any case.

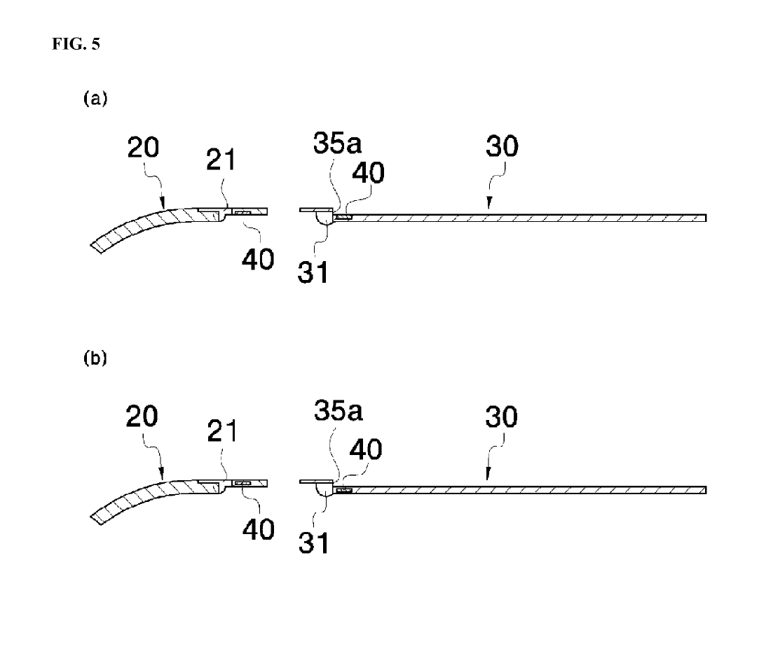

In this case, the detachable unit of the present disclosure is installed by either exposing magnets 40 on the respective surfaces of end piece 20 and leg 30 or embedding magnets 40 therein. Between the exposed and embedded installments respectively illustrated in FIG. 5 at (a) and (b), magnets 40 may choose to be exposed, embedded or both by an insert injection molding of end piece 20 and leg 30 if they are made of resin. With metal products of end piece 20 and leg 30, forming a partially penetrated groove may be followed by installing magnets 40 by inlaying or other surface preparations.

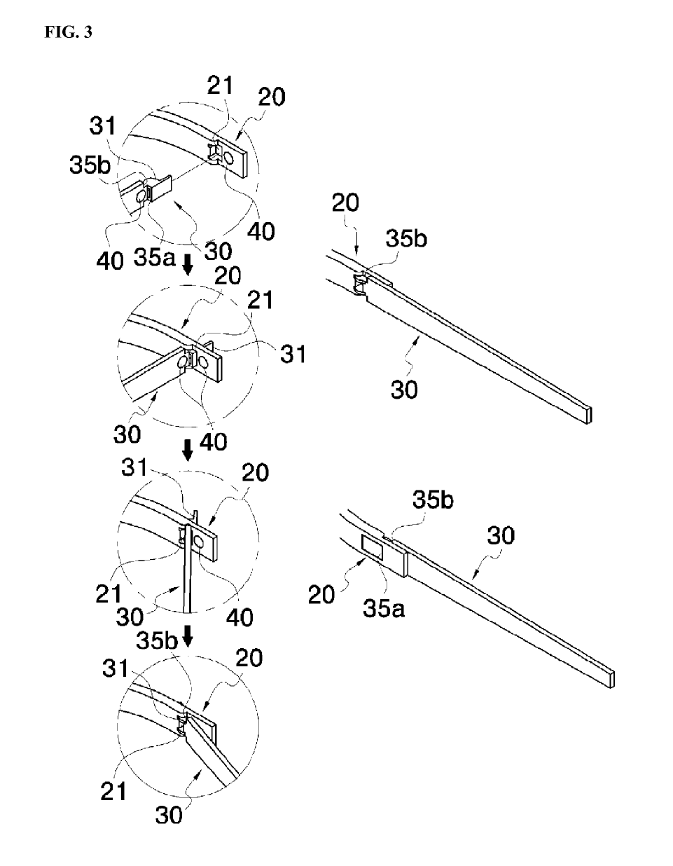

To assemble the glasses referring to FIG. 3, hinge tip 31 of leg 30 is placed in hinge groove 21 of end piece 20 followed by a further insertion and snap-in movement of leg 30 assisted by magnets 40, which completes the assembly with leg 30 abutting end piece 20. Thus, leg 30 is constrained by having its stopper 35a inserted in hinge groove 21 as other stopper 35b restricts the travel of leg 30 in folding under the magnetic hold of magnets 40, thereby maintaining leg 30 mounted upon end piece 20 in between the secured locking stops.

In reverse order, leg 30 can be detached from end piece 20 by pulling hinge tip 31 of leg 30 away from hinge groove 21 of end piece 20 in the opposite direction from the side of the magnet 40. This enables the easy and quick replacements between various designs of leg 30, allowing a partial repair and realizing more diversity of fashion.

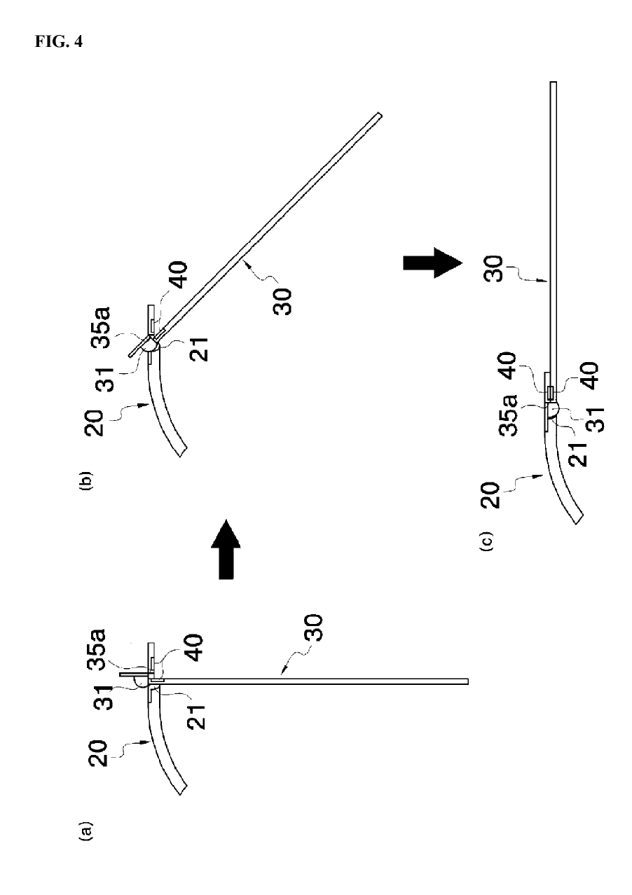

In operation as in FIG. 4, (a) shows leg 30 folded from end piece 20 maintaining hinge tip 31 in locking contact with a lateral surface of end piece 20. At the same time, stopper 35b restricts the open angle of leg 30 at the end of its unfolding travel while stopper 35a maintains the mechanical engagement with end piece 20 at another lateral side under the magnetic bias of magnets 40 to couple the two components together. This operation is carried out in cooperation with hinge groove 21 of end piece 20.

When leg 30 is swivel open as at FIG. 4 (b) and (c), it extends naturally with the magnetic assistance of magnet 40, where hinge tip 31 swivels about hinge groove 21 of end piece 20. At the end of the travel, stopper 35a keeps engaging hinge groove 21 to limit the open angle of leg 30 in operation. Stopper 35a, which maintains the interlocking engagement with hinge groove 21 of end piece 20, fully resist an attempt to open leg 30 beyond a prescribed angle while leg 30 is prevented from being separated from end piece 20 by magnets 40.

With the magnetism incorporated in coupling end piece 20 and leg 30 in the present disclosure, they are reliably provided with enduring coupling forces, facilitating the assembly of glasses and the replacement of the legs as needed. The magnetic coupling arrangement of the present disclosure obviates the need for sophisticated structures of hinge parts and renders the glasses leg to be simply foldable and compliantly wearable. Further, the present arrangement improves the replaceability of a variety of leg designs to highlight the fashionability, while lowering the manufacturing cost for the price of easier-to-use and tougher-to-break glasses.

The present disclosure is not limited to the described embodiments and various modifications and variations are obvious to a person having ordinary skill in the art, without departing from the idea and scope of the present disclosure. Accordingly, such modifications and variations shall belong to the scope of the claims of the present disclosure.

1. Eyeglasses having a frame (10) magnetically coupled with detachable legs, the eyeglasses comprising:
an end piece (20) formed on each side of the frame (10) and having a hinge groove (21);
at least one leg (30) including a hinge tip (31) for inserting the leg (30) in the hinge groove (21) of the end piece (20) for allowing the leg (30) to swivel; and
a detachable means including a number of magnets (40) combined respectively with opposing sides of the end piece (20) and the leg (30) to releasably hold the leg (30) to the end piece (20), the magnets being formed exposed, embedded or both at the opposing sides.

2. The glasses of claim 1, wherein the leg (30) has stoppers (35a, 35b) for controlling a pivotal angle range of the leg (30) in engagement with the hinge groove (21) of the end piece (20) by interfering with the swivel of the leg (30).
